(19) United States
(12) Patent Application Publication
(10) Pub. No.: US 2006/0260827 A1
(43) Pub. Date: Nov. 23, 2006

(54) Ground tending device

(76) Inventor: John Gannon Clouston, New South Wales (AU)

Correspondence Address: GORDON & JACOBSON, P.C., 60 LONG RIDGE ROAD, SUITE 407, STAMFORD, CT, 06902, US

(21) Appl. No.: 10/547,647

(22) PCT Filed: Feb. 27, 2004
(86) PCT No.: PCT/AU04/00258

§ 371 Date: May 26, 2006

(30) Foreign Application Priority Data
Mar. 4, 2003 (AU) 2003900984

(51) Int. Cl. A01B 1/00

(52) U.S. Cl. 172/378

(57) ABSTRACT

A ground-tending device (8) including a first part (10) having a cavity-forming formation having a sharp free end (15), abase portion (13.1), a side walling (13) tapering from the base portion (13.1) to the free end (15), and a second part constituted by a handle (12) extending in an opposite direction from the first part (10) away from the free end (15), the handle (12) being forked, having a plurality of tines (22), and a pressure-application surface to apply a thumb pressure thereto. Also disclosed is a method of tending a portion of ground on a golf-green using such a device. The method including the steps forming a cavity in the ground with the first formation and then working ground material surrounding the cavity towards the cavity, using the tines, so as to at least partly closing the cavity.

### FIELD OF THE INVENTION

This invention relates to a ground-tending device for use particularly on a golf-green, and to a method of using a ground-tending device.

### BACKGROUND TO THE INVENTION

During a game of golf, when a player hits a golf ball and the ball lands on a green, the ball inevitably forms an indentation on the green. This is undesirable as such an indentation can effect the ability of a ball to roll on the green smoothly. A further problem is that the grass at such an indentation is damaged due to the impact of the ball and likely to die, and, if left untended, this may cause discolouration of the green and further negatively affect the ability of a ball to roll properly.

It is an object of the invention to make provision for tending to a golf green at such an indentation.

### SUMMARY OF THE INVENTION

According to a first aspect of the invention there is provided a ground-tending device for manually tending a patch of ground, the device including:
a first part having a cavity-forming formation configured to form a cavity in the ground when pressed into the ground, the cavity-forming formation having a sharp free end, a base portion spaced from the free end and side walling tapering from the base portion to the free end, wherein the cavity-forming formation extends substantially in a first direction from the base portion to the free end; and a second part constituted by a handle extending substantially in a second direction from the first part away from the free end, the handle being forked, having a plurality of tines.

Preferably the cavity-forming formation is in the form of a cone having a central axis parallel to the first direction.

Preferably, the second direction is substantially parallel and opposite to the first direction.

In one preferred embodiment, the cavity-forming formation includes a spiral thread extending around the side walling towards the free end.

The device preferably includes a pressure-application surface adjacent the base portion and extending transversely relative to the first direction, to enable a pressure, if applied to the pressure-application surface in a direction normal thereto, to urge the cavity-forming formation in the first direction.

Preferably the pressure-application surface extends laterally relative to the second direction.

Preferably the cavity-forming formation is a first portion of the first part, the first part also including a cylindrical second portion juxtaposed with the first portion at the base portion.

Then, in a preferred embodiment, the pressure-application surface is on the cylindrical second portion on a side thereof opposite the first portion.

Preferably the first part, at the transition from the second portion to the first portion, is stepped inwards, so as to define a shoulder facing substantially in the first direction.

Preferably the first part includes a base wall which defines said pressure surface.

Preferably, the device includes a magnet. In one preferred embodiment, the device includes a magnet which constitutes at least part of the pressure-application surface, while in another preferred embodiment, the device includes a magnet which is adjacent the pressure-application surface.

In a preferred embodiment, the first part defines a recess within which the magnet is accommodated.

In one preferred embodiment, the device includes a resiliently deformable press-pad which constitutes at least part of said pressure-application surface.

According to a second aspect of the invention there is provided a method of tending a patch of ground using a ground-tending device according to the first aspect of the invention, the method including the steps of:
inserting the cavity-forming formation, free end first, by hand, into the ground, thus forming a cavity therein;
then removing the cavity-forming formation from the cavity;
then forcing the tines, by hand, into the ground at one or more positions adjacent the cavity; and
working ground material adjacent the cavity towards the cavity, by means of the tines, so as to at least partly close the cavity.

Preferably the step of inserting the cavity-forming formation includes gripping the ground-tending device by the handle. Then, preferably, where the ground-tending device is according to an embodiment as described above including a pressure-application surface, the step of inserting the cavity-forming formation includes applying finger pressure to the pressure-application surface in a direction normal thereto, thereby urging the cavity-forming formation substantially in the first direction.

Preferably, the step of forcing the tines includes holding the device by the cavity-forming formation which is used thus as a handle.

Preferably, where the ground-tending device is according to an embodiment as described above including a magnet, the method includes the step of supporting a golf green ball-marker, which is susceptible to magnetic attraction, on the device by means of the magnet.

In a preferred embodiment, the patch of ground is part of a golf-green.

### BRIEF DESCRIPTION OF THE DRAWINGS

Preferred embodiments of the invention will now be described, by way of example only, with reference to the accompanying drawings in which:

FIG. 1 is a schematic perspective view of a golf-green ground-tending device in accordance with an embodiment of the invention;

FIG. 2 is a schematic partly cut away side elevation of the device of FIG. 1, viewed from an opposite side;

FIG. 3 is a schematic plan view of the device as shown in FIG. 2;

FIG. 4 is a schematic bottom view of the device as shown in FIG. 2; and

FIG. 5 is a schematic side elevation of a device, similar to that of FIG. 1, but in accordance with another embodiment.

### DETAILED DESCRIPTION

Referring to the drawings, the ground-tending device 8 includes a first part 10, and a second part constituted by a handle 12. The first and second parts 10 and 12 are of a material such as moulded plastic, although other suitable materials may be used instead.

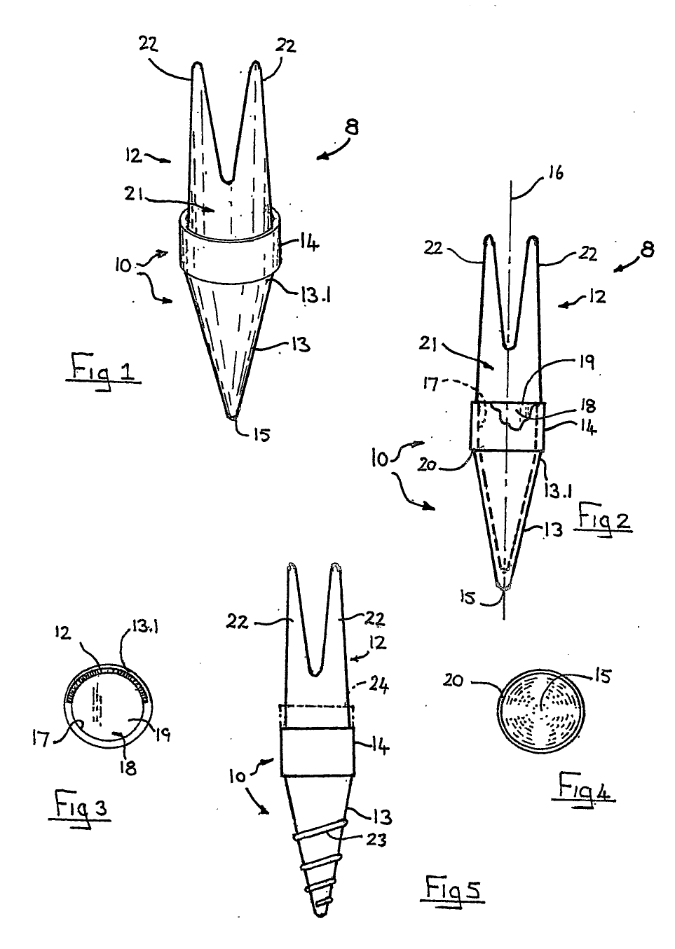

The first part 10 has a first portion 13 with side walling in the form of a hollow cone, and a second portion 14 with hollow cylindrical side walling. The conical first portion 13 has side walling which tapers to a pointed free end 15. The conical first portion 13 and second portion 14 have a central axis 16. The uppermost part 13.1 of the conical first portion 13, as shown in FIGS. 1 and 2, constitutes a base portion thereof

The conical first portion 13 defines a recess 17 (see FIG. 2) and has a cylindrically-shaped magnet 18 seated therein. In the preferred embodiment shown, the magnet 18 is held in place in the recess 17 as a press-fit or by adhesive, while in another embodiment (not shown), the magnet is fully encapsulated within the recess. Where the magnet 18 is held in place by adhesive as in the embodiment shown, its outer surface 19 constitutes a pressure-application surface, as will be described further below. Where the magnet 18 is fully encapsulated (not shown), then a wall, joined to the side walling of the second portion 14, extends over the surface 19 of the magnet 18. That wall covering the surface 19 then constitutes the pressure-application surface. In yet another embodiment (not shown) a resiliently deformable press-pad is provided, either instead of the magnet, or over the magnet, so that the press-pad constitutes the pressure-application surface. It will be appreciated that the surface 19 in the embodiment shown (or other surface constituting the pressure-application surface in the other embodiments described) constitutes what may be considered as a base wall of the first part 10.

In the preferred embodiment shown, at the transition from the second portion 14 to the first portion 13, the walling is stepped inwardly towards the axis 16, so as to form a shoulder 20 which faces in a first direction, substantially parallel to the axis, generally towards the free end 15. In another preferred embodiment (not shown) the outer diameter of the second portion 14 is substantially the same as that of the first portion 13 at the base portion 13.1 so that there is no shoulder 20.

The handle 12 also has a base portion 21, which extends from the second portion 14. The handle 12 is forked so as to have a pair of tines 22 extending from the base portion 21. The base portion 21 of the handle 12 and the tines 22 are partially rounded (around the axis 16), to correspond to the curvature of the side walling of the second portion 14, as can be seen in FIGS. 1 and 3. The handle 12, and the tines 22 in particular, extend from the second portion 14 in a second direction, opposite the above-mentioned first direction, away from the free end 15, that is, substantially parallel to the axis 16.

The device 8 is used to tend a patch of ground, particularly on a golf-green, such as a patch which has been indented by a falling golf ball. A user grips the device 8 by holding onto the handle 12, and in particular the tines 22, and then forces the pointed free end 15 and conical first portion 13 into the patch of ground so as to form a cavity (not shown) therein. The rounded shape of the handle 12, as described above, contributes to the comfort to the user when gripping the handle.

It will be appreciated that the pressure-application surface 19 referred to above extends generally laterally relative to the above-mentioned first and second directions, that is, laterally to the axis 16 and to the direction in which the handle 12 extends. Thus, the pressure-application surface 19 is configured such that the user can apply thumb pressure thereto with the same hand as that gripping the handle 12, to assist in forcing the conical first portion 13 into the ground. This feature is particularly useful where the earth of the ground is relatively hard.

In a further embodiment (see FIG. 5), there is provided a spiral screw thread 23 which is slightly proud of the outer surface of the walling of the conical first portion 13. When the device 8 is rotated, the thread 23 facilitates insertion of the first portion 13 into the ground.

The extent to which the device 8 can be pressed into the patch of ground is limited by the shoulder 20, so that the size of the cavity formed in the ground is controlled.

Once the cavity has been formed, the device 8 is removed, and inverted, and the tines 22 are then forced into the ground immediately adjacent to the cavity, using the first part 10, and particularly the conical first portion 13 thereof, as a handle. The conical shape of the first portion 13 provides a surface which is suitably angled, by having a component of its area projected parallel to the axis 16, to facilitate the pressing, by the user, of the tines 22 into the ground.

The tines 22 are then used, at successive positions around the cavity, to work the surrounding earth into the cavity. This process results in the earth, that was initially at the indentation in the patch of ground (i.e. the indentation caused by the golf ball), firstly being pushed outwardly by the conical first portion 13 towards the surrounding earth, and then that earth that was pushed outwardly, together with portions of the surrounding earth, being pushed inwardly again, by the tines 22. This process, in turn, facilitates regeneration of grass at the patch of ground by airating the grass at that location, and hence repair of the golf-green. Thus, the scarring of the green by grass which is killed by the impact of a golf ball, and the detrimental effect that this has on the ability of a golf ball to roll smoothly on the green, is minimised.

The magnet 18 provides a convenient means of holding a golf-green ball-marker 24 (indicated in broken lines in FIG. 5)—that is, a marker for marking positions of a golf ball on the golf-green during a game of golf—where the ball-marker is of a material, such as suitable metal, susceptible to magnet attraction. When the ball-marker 24 is held in place thus, the ball-marker itself can serve as the pressure-application surface on which the user can apply thumb pressure to insert the conical first portion 13 into the ground.

Although the invention is described above with reference to specific embodiments, it will be appreciated by those skilled in the art that the invention is not limited to these embodiment, and may be embodied in other forms as well.

1. A ground-tending device for manually tending a patch of ground, the device including:
a first part having a cavity-forming formation configured to form a cavity in the ground when pressed into the ground, the cavity-forming formation having a sharp free end, a base portion spaced from the free end and side walling tapering from the base portion to the free end, wherein the cavity-forming formation extends substantially in a first direction from the base portion to the free end; and
a second part constituted by a handle extending substantially in a second direction from the first part away from the free end, the handle being forked, having a plurality of tines.

2. A device according to claim 1 wherein the cavity-forming formation is in the form of a cone having a central axis parallel to the first direction.

3. A device according to claim 2 wherein the second direction is substantially parallel and opposite to the first direction.

4. A device according to claim 2 wherein the cavity-forming formation includes a spiral thread extending around the side walling towards the free end.

5. A device according to claim 1 including a pressure-application surface adjacent the base portion and extending transversely relative to the first direction, to enable a pressure, if applied to the pressure-application surface in a direction normal thereto, to urge the cavity-forming formation in the first direction.

6. A device according to claim 5 wherein the pressure-application surface extends laterally relative to the second direction.

7. A device according to claim 5 wherein the cavity-forming formation is a first portion of the first part, the first part also including a cylindrical second portion juxtaposed with the first portion at the base portion.

8. A device according to claim 7 wherein the pressure-application surface is on the cylindrical second portion on a side thereof opposite the first portion.

9. A device according to claim 8 wherein the first part, at the transition from the second portion to the first portion, is stepped inwards, so as to define a shoulder facing substantially in the first direction.

10. A device according to claim 5 wherein the first part includes a base wall which defines said pressure surface.

11. A device according to claim 5 including a magnet which constitutes at least part of the pressure-application surface.

12. A device according to claim 5 including a magnet which is adjacent the pressure-application surface.

13. A device according to claim 11 wherein the first part defines a recess within which the magnet is accommodated.

14. A device according to claim 5 including a resiliently deformable press-pad which constitutes at least part of said pressure-application surface.

15. A device according to claim 1, including a magnet.

16. A method of tending a patch of ground using a ground-tending device according to claim 1, the method including the steps of:
inserting the cavity-forming formation, free end first, by hand, into the ground, thus forming a cavity therein;
then removing the cavity-forming formation from the cavity;
then forcing the tines, by hand, into the ground at one or more positions adjacent the cavity; and
working ground material adjacent the cavity towards the cavity, by means of the tines, so as to at least partly close the cavity.

17. A method according to claim 16 wherein the step of inserting the cavity-forming formation includes gripping the ground-tending device by the handle.

18. A method according to claim 16 wherein the ground-tending device includes a pressure-application surface adjacent the base portion and extending transversely relative to the first direction, to enable a pressure, if applied to the pressure-application surface in a direction normal thereto, to urge the cavity-forming formation in the first direction wherein the step of inserting the cavity-forming formation includes applying finger pressure to the pressure-application surface in a direction normal thereto, thereby urging the cavity-forming formation substantially in the first direction.

19. A method according to claim 16 wherein the step of forcing the tines includes holding the device by the cavity-forming formation which is used thus as a handle.

20. A method according to claim 16 wherein the ground-tending device is a ground-tending device which includes a magnet, including the step of supporting a golf green ball-marker, which is susceptible to magnetic attraction, on the device by means of the magnet.

22. (canceled)

21. A method according to claim 16 wherein the patch of ground is part of a golf-green.

24-25. (canceled)
